(19) United States
(12) Patent Application Publication
(10) Pub. No.: US 2015/0153917 A1
(43) Pub. Date: Jun. 4, 2015

(54) UNIVERSAL VISUALIZATION COMPONENT INTERFACE

(71) Applicant: Halliburton Energy Services, Inc., Houston, TX (US)

(72) Inventors: XinGang LV, Beijing (CN); Xuhui Duan, Beijing (CN)

(73) Assignee: Halliburton Energy Services, Inc., Houston, TX (US)

(21) Appl. No.: 14/093,721

(22) Filed: Dec. 2, 2013

(51) Int. Cl. G06F 3/0484

(52) U.S. Cl. CPC G06F 3/0484

(57) ABSTRACT

According to aspects of the present disclosure, an example method for visualizing data may include generating an interface component in response to a first command from a processing component. The interface component may receive data in a first format from the processing component, and may determine an adapter associated with the processing component. The adapter further may be associated with a visualization component. The adapter may be generated in response to a second command from the interface component, and may covert the data from the first format to a second format associated with the visualization component. The adapter may issue a third command to generate the visualization component.

### BACKGROUND

The present disclosure relates generally to the creation of visualizations using a data set and, more particularly, to a universal visualization component interface to generate visualizations of data collected during subterranean drilling operations.

Hydrocarbons, such as oil and gas, are commonly obtained from subterranean formations that may be located onshore or offshore. The development of subterranean operations and the processes involved in removing hydrocarbons from a subterranean formation are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation.

Measurements of the subterranean formation may be made throughout the operations to characterize the formation and aide in making operational decisions. In certain instances, these measurements may be processed and visualized as charts, graphs, or other visual forms that can be utilized by operators. The software components for processing the measurements and generating the visualizations, however, can be complex, and are often designed and produced by independent parties using different types of interfaces and coding schemes.

### FIGURES

Some specific exemplary embodiments of the disclosure may be understood by referring, in part, to the following description and the accompanying drawings.

FIG. 1 is a diagram showing an illustrative logging while drilling environment, according to aspects of the present disclosure.

FIG. 2 is a diagram showing an illustrative wireline logging environment, according to aspects of the present disclosure.

FIG. 3 is a diagram of an example information handling system, according to aspects of the present disclosure.

FIG. 4 is a diagram of an existing software component structure.

FIG. 5 is a diagram of an example software component structure with an interface and adapters, according to aspects of the present disclosure.

FIG. 6 is a diagram illustrating an example process for producing a visualization, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would, nevertheless, be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

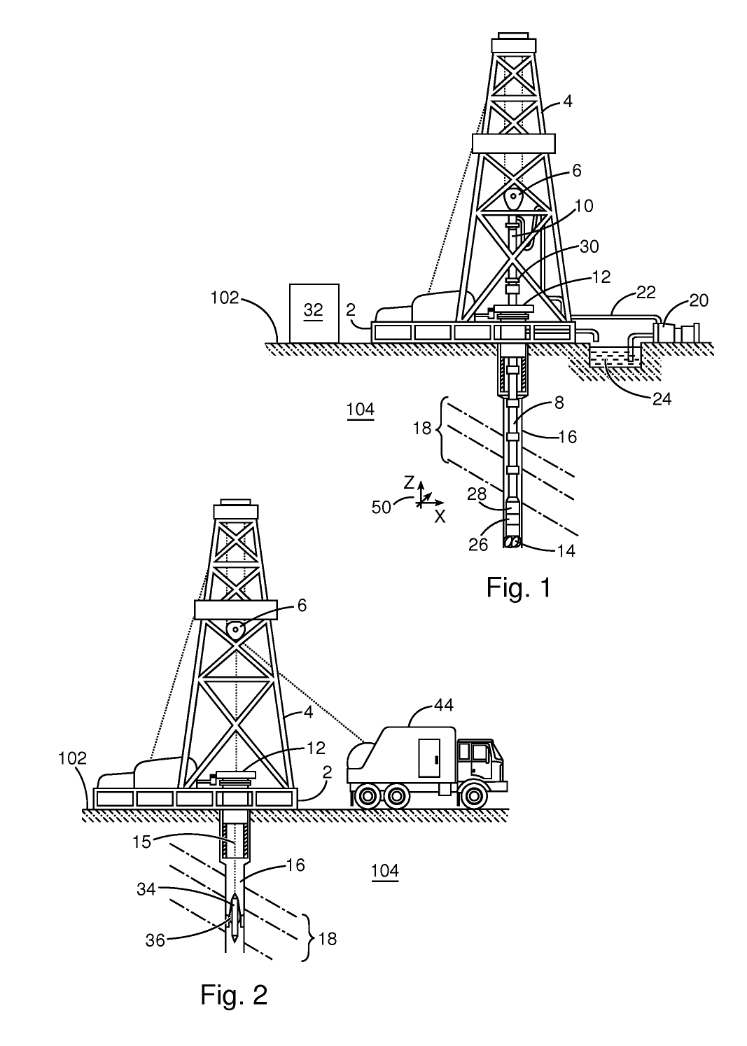

FIG. 1 is a diagram of a subterranean drilling system 100, according to aspects of the present disclosure. The drilling system 100 comprises a drilling platform 2 positioned at the surface 102. In the embodiment shown, the surface 102 comprises the top of a formation containing one or more rock strata or layers 18, and the drilling platform 2 may be in contact with the surface 102. In other embodiments, such as in a off-shore drilling operation, the surface 102 may be separated from the drilling platform 2 by a volume of water.

The drilling system 100 comprises a derrick 4 supported by the drilling platform 2 and having a traveling block 6 for raising and lowering a drill string 8. A kelly 10 may support the drill string 8 as it is lowered through a rotary table 12. A drill bit 14 may be coupled to the drill string 8 and driven by a downhole motor and/or rotation of the drill string 8 by the rotary table 12. As bit 14 rotates, it creates a borehole 16 that passes through one or more rock strata or layers 18. A pump 20 may circulate drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the borehole 16 into the pit 24 and aids in maintaining integrity or the borehole 16.

The drilling system 100 may comprise a bottom hole assembly (BHA) coupled to the drill string 8 near the drill bit 14. The BHA may comprise a LWD/MWD tool 26 and a telemetry element 28. In certain embodiments, the LWD/MWD tool 26 may be integrated at any point along the drill string 8. The LWD/MWD tool 26 may include receivers and/or transmitters (e.g., antennas capable of receiving and/or transmitting one or more electromagnetic signals). In some embodiments, the LWD/MWD tool 26 may include a transceiver array that functions as both a transmitter and a receiver. As the bit extends the borehole 16 through the formations 18, the LWD/MWD tool 26 may collect measurements relating to various formation properties as well as the tool orientation and position and various other drilling conditions. The orientation measurements may be performed using an azimuthal orientation indicator, which may include magnetometers, inclinometers, and/or accelerometers, though other sensor types such as gyroscopes may be used in some embodiments. In embodiments including an azimuthal orientation indicator, resistivity and/or dielectric constant measurements may be associated with a particular azimuthal orientation (e.g., by azimuthal binning). The telemetry sub 28 may transfer measurements from the LWD/MWD tool 26 to a surface receiver 30 and/or to receive commands from the surface receiver 30. Measurements taken at the LWD/MWD tool 26 may also be stored within the tool 26 for later retrieval when the LWD/MWD tool 26 is removed from the borehole 16.

In certain embodiments, the drilling system 100 may comprise an information handling system 32 positioned at the surface 102. The information handling system 32 may be communicably coupled to the surface receiver 30 and may receive measurements from the LWD/MWD tool 26 and/or transmit commands to the LWD/MWD tool 26 though the surface receiver 30. The information handling system 32 may also receive measurements from the LWD/MWD tool 26 when it is retrieved at the surface 102. In certain embodiments, the information handling system 32 may process the measurements to determine certain characteristics of the formation 104 (e.g., resistivity, permeability, conductivity, porosity, etc.) In some cases, the measurements and formation characteristics may be plotted, charted, or otherwise visualized at the information handling system 32 to allow drilling operators to alter the operation of the drilling system 100 to account for downhole conditions.

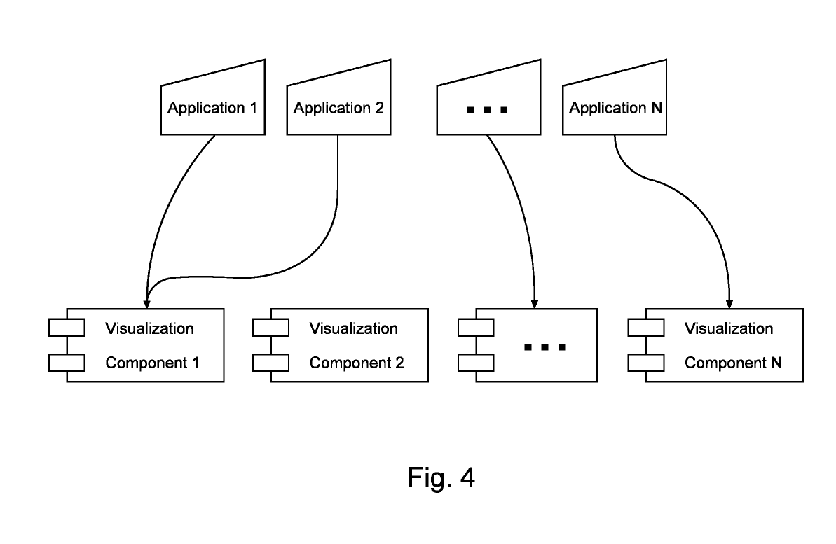

At various times during the drilling process, the drill string 8 may be removed from the borehole 16 as shown in FIG. 2. Once the drill string 8 has been removed, measurement/logging operations can be conducted using a wireline tool 34, i.e., an instrument that is suspended into the borehole 16 by a cable 15 having conductors for transporting power to the tool and telemetry from the tool body to the surface 102. The wireline tool 34 may include one or more logging/measurement tools 36 having transmitters, receivers, and/or transceivers similar to those described above in relation to the LWD/MWD tool 26. The logging/measurement tool 36 may be communicatively coupled to the cable 15. A logging facility 44 (shown in FIG. 4 as a truck, although it may be any other structure) may collect measurements from the logging tool 36, and may include computing facilities (including, e.g., an information handling system) for controlling, processing, storing, and/or visualizing the measurements gathered by the logging tool 36. The computing facilities may be communicatively coupled to the logging/measurement tool 36 by way of the cable 15. In certain embodiments, the information handling system 32 may serve as the computing facilities of the logging facility 44.

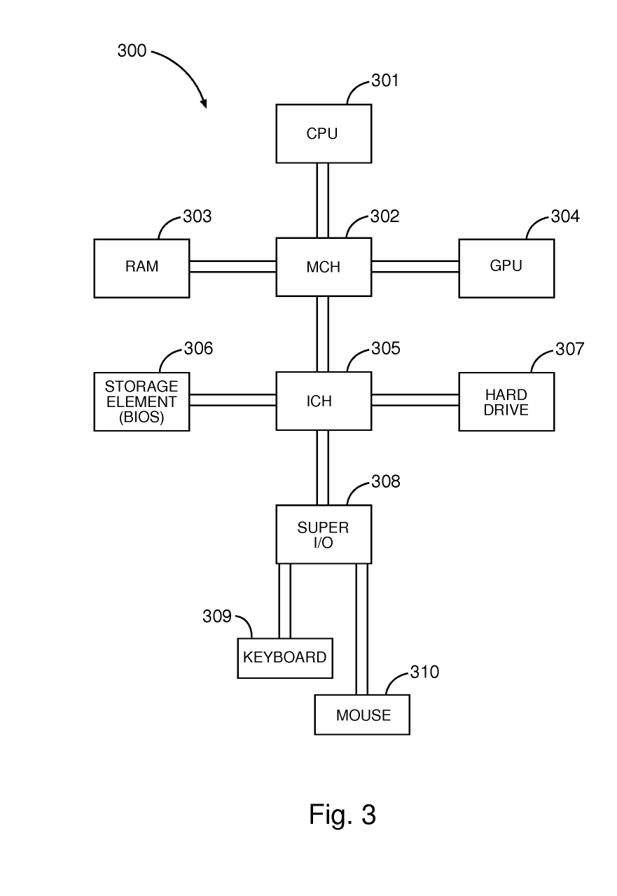

FIG. 3 is a block diagram showing an example information handling system 300, according to aspects of the present disclosure. Information handling system 300 may be used with the drilling system described above and with other subterranean drilling systems. The information handling system 300 may comprise a processor or CPU 301 that is communicatively coupled to a memory controller hub or north bridge 302. Memory controller hub 302 may include a memory controller for directing information to or from various system memory components within the information handling system, such as RAM 303, storage element 306, and hard drive 307. The memory controller hub 302 may be coupled to RAM 303 and a graphics processing unit 304. Memory controller hub 302 may also be coupled to an I/O controller hub or south bridge 305. I/O hub 305 is coupled to storage elements of the computer system, including a storage element 306, which may comprise a flash ROM that includes a basic input/output system (BIOS) of the computer system. I/O hub 305 is also coupled to the hard drive 307 of the computer system. I/O hub 305 may also be coupled to a Super I/O chip 308, which is itself coupled to several of the I/O ports of the computer system, including keyboard 309 and mouse 310. The information handling system 300 further may be communicably coupled to one or more elements of a drilling system though the chip 308 as well as a visualization mechanism, such as a computer monitor or display.

The information handling systems described above may include software components that process and characterize data and software components that generate visualizations from the processed data. As used herein, software or software components may comprise a set of instructions stored within a computer readable medium that, when executed by a processor coupled to the computer readable medium, cause the processor to perform certain actions. In the case of a data characterization/processing component, the set of instructions may cause the processor to receive “raw” data from a data source (e.g., measurements from a LWD/MWD tool), and to process the “raw” using various algorithms or other processing techniques that would be appreciated by one of ordinary skill in the art in view of this disclosure and the purposes to be achieved by the data processing. In the case of a software component that generates visualizations, the set of instructions may cause the processor to receive processed data from a data characterization/processing component and generate a visualization (e.g, chart, graph, plot, 3-D environment, etc.) based on that data.

FIG. 4 illustrates an existing software component structure comprising a plurality of data characterization/processing components, referred to as Applications 1-N, and a plurality of visualization components 1-N. Each of the visualization components 1-N may produce unique visualizations using input data from an Application when instantiated by a unique call command from the Application, and may require a different, pre-defined format for the input data in order to produce the corresponding visualization. Each of the Applications 1-N are programmed or coded to correspond to a particular visualization component, so that each Application is capable of calling and passing input data in the correct format to the corresponding visualization component. For example, Application 1 is coded to call visualization component 1 when a visualization is required, and is also coded to produce data in the pre-defined format of visualization component 1. In order to call others of the visualization components 1-N to produce different types of visualizations, Application 1 must also contain code specific to the other visualization components. Adding the additional code may be difficult, however, given that programmers of the Applications must know the data formats and call commands of the visualization components, yet many of the visualization components are developed by third-parties.

According to aspects of the present disclosure, an interface component may be used as an intermediary between the Applications 1-N and the visualization components 1-N. As will be described below, the Applications 1-N may be coded to call the interface component rather than an individual visualization component and to output data in a standard format of the interface component which may be converted or adapted into the data format of a particular visualization component. Using the interface component may increase the flexibility of the Applications and the visualizations produced using data from the Applications, and reduce the dependency between the Applications and the visualization components.

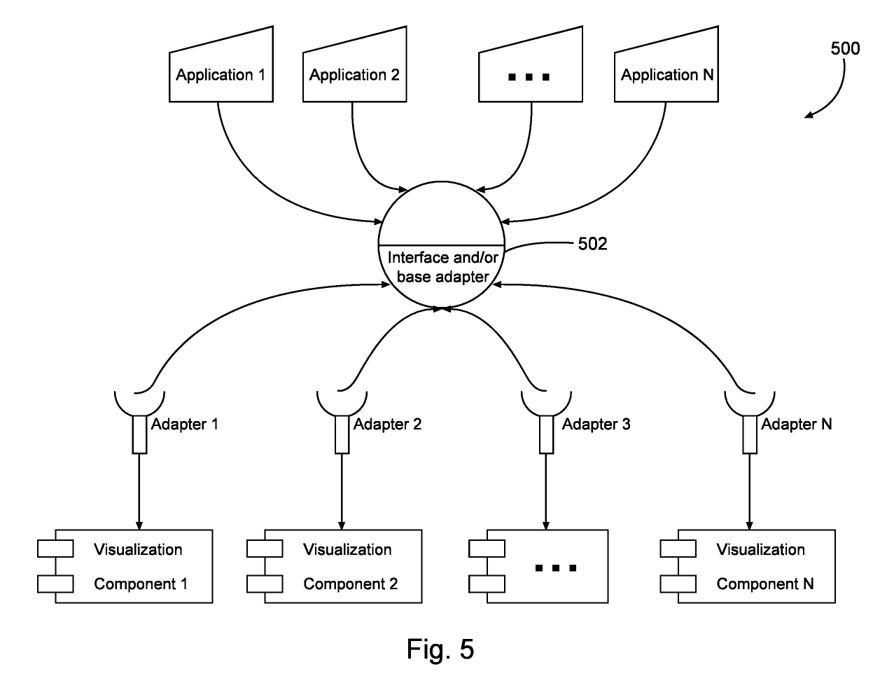

FIG. 5 is a diagram illustrating an example software component structure 500 with an interface component 502, according to aspects of the present disclosure. The software component structure 500 comprises Application 1-N and visualization components 1-N, with the interface component 502 positioned as an intermediary between the Applications 1-N and the visualization components 1-N. Each of the Applications 1-N may contain code to call an instance of the interface component 502 when a visualization is required. As used herein an instance of a software component may comprise one version of the software component that is being executed at a given time, with the simultaneous execution of multiple instances being possible, depending on the system. The call command may be standard for the interface component 502 and may cause a processor to copy instructions corresponding to the interface component 502 from a memory location and create an active instance of the interface component 502.

In certain embodiments, the interface component 502 may accept data from the Applications 1-N in a standard format. Each of the Applications 1-N may contain code corresponding to the standard format such that they output data to the interface component 502 in the standard format. Notably, because the call command and data format for the interface component 502 is standard, programming the Applications 1-N is simpler, as is the process for adding new visualization components that can be accessed by the Applications 1-N, as will be described below.

In certain embodiments, the software component structure 500 may comprise one or more adapters 1-N, each corresponding to a different one of the visualization components 1-N. The interface component 502 may contain instructions to call an instance of each of the adapters 1-N. The adapter 1-N that is called by the interface component 502 may depend, at least in part, on the Application that instantiated the interface component 502 and/or the data passed from the Application to the interface component 502. In one embodiment, as will be described in detail below, the interface component 502 may choose one of the adapters 1-N to call based on a configuration or database file containing information about the Application that called the interface component 502. The interface component 502 may identify a visualization component and/or adapter for the Application based on the configuration or database file, and may call an instance of the adapter corresponding to that visualization component.

Each adapter 1-N may contain instructions to call or create an instance of the corresponding visualization component 1-N as well as instructions regarding the data format accepted by the corresponding visualization component 1-N. Once created by the interface component 502, an adapter instance may receive data from the interface component 502 and call an instance of the corresponding visualization component. The adapter may take the data from the interface component 502, which may be in the standard format of the interface component 502, and modify, change, or reformat the data to meet the format required by the corresponding visualization component. The visualization component may then output the visualization.

Notably, by locating the instructions for the specific call commands and data formats within the interface component 502 and adapters 1-N, the code for the Applications 1-N can be simplified. Specifically, the Applications 1-N no longer need specific instructions for each one of the visualization components. This allows for the Applications 1-N to easily switch between different visualization components using the interface component 502, without significant programming with respect to the Applications 1-N. Additionally, when new visualization components are added, the call commands and data formats can be addressed within the interface component 502 and adapters 1-N, rather than requiring substantial changes to the Applications 1-N. Other advantages would be appreciated by one of ordinary skill in the art in view of this disclosure.

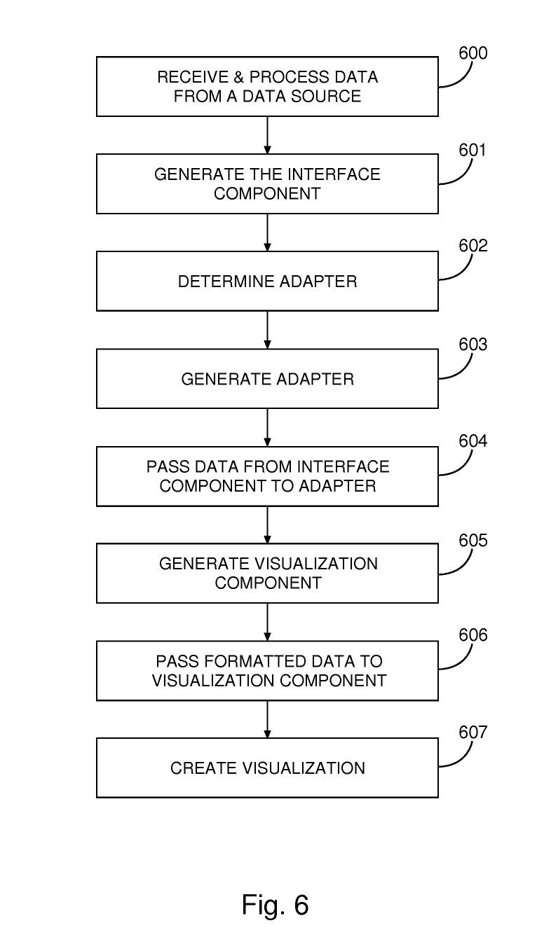

FIG. 6 is a diagram illustrating an example process for producing a visualization, according to aspects of the present disclosure. Step 600 of the process may comprise receiving and processing data from a data source at an information handling system. In certain embodiments, the data may comprise a measurement or a set of measurements and the data source may comprise a downhole tool, such as a wireline logging/measuring tool or a LWD/MWD tool. The measurements may be received at the information handling system through a communications channel with the downhole tool, or may be received at the information handling system once the downhole tool is retrieved at the surface. Processing the data may comprise processing the data at an application within the information handling system to determine formation characteristics using the data. Once the data is processed, the user of the application or the application automatically may decide to generate a visualization of the processed data.

Once the decision to generate a visualization is made, the application may directly call an interface component at step 601, causing an instance of the interface component to be created. Calling the interface component may further include transmitting the processed data to the interface component. At step 602, the interface component may determine an adapter corresponding to the application. In certain embodiments, a configuration or database file stored within the information handling system and accessible by the interface component may contain a listing of each application within the information handling system and the adapter name/type of the visualization component associated with each application. Determining the adapter corresponding to the application may comprise accessing the configuration or database file and identifying the adapter name/type associated with the application. In other embodiments, a configuration file specific to the application may include the adapter name/type associated with the application, and determining the adapter corresponding to the application may comprise accessing the file to determine the associated adapter name/type. Notably, using a different visualization component with a given Application requires only accessing one of the configuration files and changing the associated adapter, rather than adding code to the Application specific to the new or different visualization component.

At step 603, an instance of the adapter associated with the application may be created. In certain embodiments, the interface component may issue a call command for the adapter, causing an instance of the adapter to be created. At step 604, once the adapter instance is created, the interface component may pass to the adapter instance the data from the application and all other information required by adapter and the visualization component corresponding to the adapter. The adapter instance may then change, modify, alter, or reformat the data according to the data format required by the corresponding visualization component. At step 605, the adapter may issue a call command for the corresponding visualization component, causing an instance of the visualization component to be created. At step 606, the adapter instance may pass the reformatted data to the visualization component instance, which may generate a visualization of the data at step 607. After creating the visualization, the visualization component, adapter, and interface component instances may be deleted.

It should be noted that this process may be run simultaneously with multiple applications, some of which using the same adapter and visualization components. Additionally, although the process is described with respect to measurements from downhole tools in a subterranean drilling operation, the software component structure, interface component, and process described above may be used with other data types and visualization types. Moreover, the each of the steps of the process described above and each of the Applications, interface components, adapters, and visualization components may be generated, processed, and/or executed using a processor of an information handling system that executes instructions stored within a computer readable medium communicably coupled to the processor.

According to aspects of the present disclosure, an example method for visualizing data may include generating an interface component in response to a first command from a processing component. The interface component may receive data in a first format from the processing component, and may determine an adapter associated with the processing component. The adapter further may be associated with a visualization component. The adapter may be generated in response to a second command from the interface component, and may covert the data from the first format to a second format associated with the visualization component. The adapter may issue a third command to generate the visualization component. In certain embodiments, the data from the from the processing component may comprise downhole measurement data processed by the processing component, but other types of data are possible.

The processing component may comprise one of a plurality of processing components stored within an information handling system, and each of the plurality of processing components may comprise the first command and generate data in the first format. The first command and the first format are associated with the interface component. In certain embodiments, the adapter may comprise one of a plurality of adapters stored within the information handling system, and each of the plurality of adapters may be associated with a different one of a plurality of visualization components that includes the visualization component.

In certain embodiments, the adapter associated with the processing component may be determined using a configuration file that contains a list of the plurality of processing components. The configuration file may be received and the adapter associated with the processing component determined based, at least in part, on the list. In certain embodiments, the configuration file may be associated with online the processing component, and the adapter associated with the processing component may be determined, at least in part, using the configuration file. Each of the plurality of adapters may include a command for and output data in a format accepted by the associated visualization component. An the method may further include generating a visualization at the visualization component.

According to aspects of the present disclosure, an example system for visualizing data may include a processing component that comprises a first command and outputs data in a first format, and a visualization component associated a second format. The system may further include a processor and a memory device communicably coupled to the processor. The memory device may contain a set of instructions that, when executed by the processor, cause the processor to perform certain actions. For example, the processor may generate an interface component in response to the first command from the processing component. Data in the first format may be received from the processing component through the interface component. The processor may determine an adapter associated with the processing component, and generate the adapter in response to a second command from the interface component. The adapter may be associated with the visualization component. Additionally, the processor may convert the data from the first format to the second format, and issue from the adapter a third command to generate the visualization component. In certain embodiments, the data from the from the processing component may comprise downhole measurement data processed by the processing component, but other types of data are possible.

The processing component may comprise one of a plurality of processing components stored within an information handling system, and each of the plurality of processing components may comprise the first command and generate data in the first format. The first command and the first format are associated with the interface component. In certain embodiments, the adapter may comprise one of a plurality of adapters stored within the information handling system, and each of the plurality of adapters may be associated with a different one of a plurality of visualization components that includes the visualization component.

In certain embodiments, the adapter associated with the processing component may be determined by the processor using a configuration file that contains a list of the plurality of processing components. The configuration file may be received and the adapter associated with the processing component determined based, at least in part, on the list. In certain embodiments, the configuration file may be associated with online the processing component, and the adapter associated with the processing component may be determined, at least in part, using the configuration file. Each of the plurality of adapters may include a command for and output data in a format accepted by the associated visualization component. The set of instructions may further cause the processor to generate a visualization at the visualization component.

According to aspects of the present disclosure an example non-transitory, computer readable medium may contain a set of instructions that when executed by a processor cause the processor to generate an interface component in response to a first command from a processing component and receive data in a first format from the processing component through the interface component. An adapter associated with the processing component may be determined, and generated in response to a second command from the interface component. The adapter may be associated with a visualization component. The adapter may convert the data from the first format to a second format associated with the visualization component, and issue a third command to generate the visualization component. In certain embodiments, the data from the from the processing component may comprise downhole measurement data processed by the processing component, but other types of data are possible.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A method comprising:
generating an interface component in response to a first command from a processing component;
receiving data in a first format from the processing component at the interface component;
determining an adapter associated with the processing component, the adapter further associated with a visualization component;
generating the adapter in response to a second command from the interface component;
converting at the adapter the data from the first format to a second format associated with the visualization component; and
issuing from the adapter a third command to generate the visualization component.

2. The method of claim 1, wherein receiving data from the processing component at the interface component comprises receiving downhole measurement data processed by the processing component at the interface component.

3. The method of claim 1, wherein
the processing component comprises one of a plurality of processing components stored within an information handling system;
each of the plurality of processing components comprises the first command and generates data in the first format; and
the first command and the first format are associated with the interface component.

4. The method of claim 3, wherein
the adapter comprises one of a plurality of adapters stored within the information handling system; and
each of the plurality of adapters is associated with a different one of a plurality of visualization components that includes the visualization component.

5. The method of claim 4, wherein determining the adapter associated with the processing component comprises
receiving a configuration file containing a list of the plurality of processing components; and
determining the adapter associated with the processing component based, at least in part, on the list.

6. The method of claim 1, wherein determining the adapter associated with the processing component comprises
receiving a configuration file for the processing component; and
determining the adapter associated with the processing component based, at least in part, on the configuration file.

7. The method of claim 4, wherein each of the plurality of adapters includes a command for and outputs data in a format accepted by the associated visualization component.

8. The method of claim 1, further comprising generating a visualization at the visualization component.

9. A system comprising:
a processing component that comprises a first command and outputs data in a first format;
a visualization component associated a second format;
a processor; and
a memory device communicably coupled to the processor, the memory device containing a set of instruction that, when executed by the processor, cause the processor to
generate an interface component in response to the first command from the processing component;
receive data in the first format from the processing component through the interface component,
determine an adapter associated with the processing component,
generate the adapter in response to a second command from the interface component, the adapter associated with the visualization component;
convert the data from the first format to the second format; and
issue from the adapter a third command to generate the visualization component.

10. The system of claim 9, wherein the data comprises downhole measurement data processed by the processing component.

11. The system of claim 9, wherein
the processing component comprises one of a plurality of processing components stored within an information handling system; and
each of the plurality of processing components comprises the first command and outputs data in the first format; and
the first command and the first format are associated with the interface component.

12. The system of claim 11, wherein
the adapter comprises one of a plurality of adapters stored within the information handling system; and
each of the plurality of adapters is associated with a different one of a plurality of visualization components that includes the visualization component.

13. The system of claim 12, wherein the set of instructions that cause the processor to determine the adapter associated with the processing component further cause the processor to
receive a configuration file containing a list with the plurality of processing components; and
determine the adapter associated with the processing component based, at least in part, on the list.

14. The system of claim 9, wherein the set of instructions that cause the processor to determine the adapter associated with the processing component further cause the processor to
receive a configuration file for the processing component; and
determining the adapter associated with the processing component based, at least in part, on the configuration file.

15. The system of claim 12, wherein the adapter comprises the third command for the visualization component.

16. The system of claim 9, wherein the set of instructions further cause the processor to generate a visualization at the visualization component.

17. A non-transitory, computer readable medium containing a set of instructions that when executed by a processor cause the processor to:
generate an interface component in response to a first command from a processing component;
receive data in a first format from the processing component through the interface component,
determine an adapter associated with the processing component,
generate the adapter in response to a second command from the interface component, the adapter associated with a visualization component;
convert at the adapter the data from the first format to a second format associated with the visualization component; and
issue from the adapter a third command to generate the visualization component.

18. The non-transitory, computer readable medium of claim 17, wherein the data comprises downhole measurement data processed by the first processing component.

19. The non-transitory, computer readable medium of claim 18, wherein
the processing component comprises one of a plurality of processing components stored within an information handling system; and
each of the plurality of processing components comprises the first command and outputs data in the first format; and
the first command and the first format are associated with the interface component.

20. The non-transitory, computer readable medium of claim 19, wherein
the adapter comprises one of a plurality of adapters; and
each of the adapters is associated with a different one of a plurality of visualization components that includes the visualization component.
